(19) United States
(12) Patent Application Publication
(10) Pub. No.: US 2014/0219401 A1
(43) Pub. Date: Aug. 7, 2014

(54) RFI MITIGATION VIA DUTY CYCLE CONTROL

(71) Applicants: Koby Finkelstein, Kfar Saba (IL); Itamar Levin, Holon (IL)

(72) Inventors: Koby Finkelstein, Kfar Saba (IL); Itamar Levin, Holon (IL)

(21) Appl. No.: 13/757,927

(22) Filed: Feb. 4, 2013

(51) Int. Cl. H04B 1/10

(52) U.S. Cl. CPC H04B 1/10
USPC 375/346; 327/175

(57) ABSTRACT

Briefly, in accordance with one or more embodiments, a harmonic of a clock signal is determined that is expected to provide interference with an input of a radio-frequency (RF) receiver based at least in part on a frequency of the clock signal and one or more frequencies of operation of the RF receiver. A duty cycle of the clock signal at which the harmonic will be attenuated is calculated, and the duty cycle of the clock signal is set to the calculated value as a base duty cycle in order to mitigate RF interference (RFI) at the RF receiver due to the harmonic of the clock signal. In one or more embodiments, the power level of the harmonic may be measured as the duty cycle may be swept over a range near the base duty cycle, and the duty cycle may be set to a value in the range at which the harmonic is minimized or reduced below a threshold value.

### BACKGROUND

Clock signals are used to synchronize the operation of digital circuits. Driving clock signals off a clock chip generates harmonics of the fundamental clock signal that may interfere with one or more radio-frequency (RF) receivers or transceivers as radio-frequency interference (RFI). Although RFI typically may impact RF receivers and/or transceivers, other types of circuits may also be impacted by RFI, for example, analog-to-digital converters (ADCs), sensors, imaging circuits, control circuits, and so on. In some cases, there may be no freedom to select the frequencies at which the clock chips and RF receivers operate, in which case such interference may be unavoidable. Furthermore, some approaches to mitigating electromagnetic interference (EMI) in order to reduce the emissions from a device into the ambient environment using spread spectrum techniques may actually cause RFI problems by broadening the harmonic bandwidth of the clock signals.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a system to mitigate RFI via duty cycle control in accordance with one or more embodiments;

FIG. 2 is a plot of an example clock signal in accordance with one or more embodiments;

FIG. 3 is a plot of example harmonics of a clock signal at various duty cycles in accordance with one or more embodiments;

FIG. 4 is a plot of power versus duty cycle for one specific example harmonic of a clock signal in accordance with one or more embodiments;

FIG. 5 is a flow chart of a method to mitigate RFI via duty cycle control in accordance with one or more embodiments;

FIG. 6 is a block diagram of an information handling system capable of mitigating RFI via duty cycle control in accordance with one or more embodiments; and

FIG. 7 is an isometric view of an information handling system of FIG. 6 that optionally may include a touch screen in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Noise coupled or power coupled may mean that two or more elements are close enough together to form a common electromagnetic field which may result in one element electromagnetically disturbing the other. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

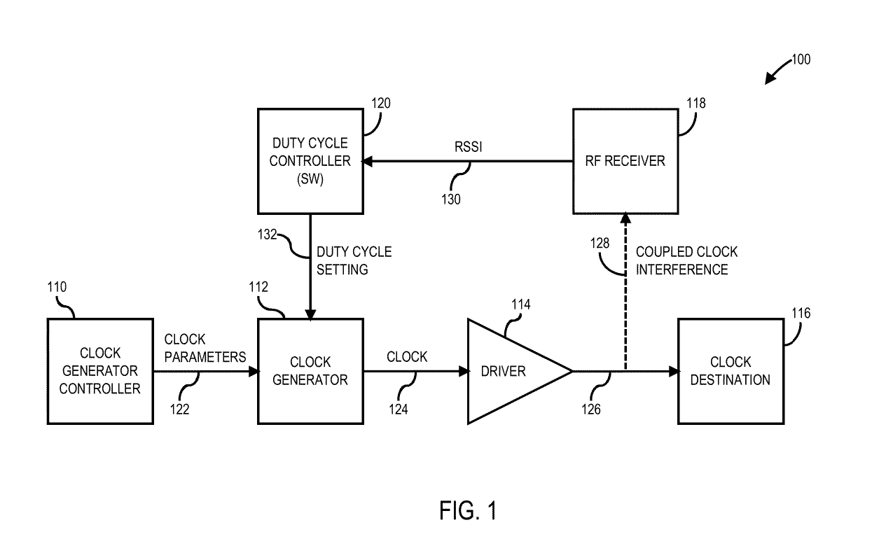

Referring now to FIG. 1, a block diagram of a system to mitigate radio-frequency interference (RFI) via duty cycle control in accordance with one or more embodiments will be discussed. As shown in FIG. 1, system 100 may comprise any user equipment (UE), device, computer, cellular telephone, smartphone, tablet, or any other platform that includes digital circuits or subsystems that use a clock signal for synchronous operation of the circuits or subsystems along with one or more radio-frequency (RF) receivers or transceivers. Such a system 100 may include a clock generator controller 110 to provide clock parameters 122 to a clock generator 112. The clock generator 112 generates a clock signal 124 that may be provided over a clock bus 126 to one or more clock destinations 116 comprising a circuit, device, or subsystem of the system 100, via driver 114. System 100 may also include an RF receiver 118 which may be a stand-alone receiver or part of an RF transceiver in some embodiments. Since a clock signal 124 typically comprises a square wave or trapezoidal wave due to finite rise and fall times, the clock signal 124 may have one or more harmonics above the fundamental frequency of the clock signal 124 wherein one or more harmonics may fall in a radio-frequency range of operation of the RF receiver 118. As a result, the clock signal 124 on the clock bus 126 may generate unintended coupled clock interference 128 with the RF receiver 118 that may interfere with the operation of the RF receiver 118 as radio-frequency interference (RFI). Although an RF receiver 118 is illustrated for purposes of example, it should be noted that other circuits sensitive to RFI likewise may substituted therefor, for example analog-to-digital converters (ADCs), imaging circuits, control circuits, sensors, high speed circuits, circuits having a high input impedance, video circuits, radio-frequency transceivers, and so on, and the scope of the claimed subject matter is not limited in this respect. Furthermore, although a clock signal is discussed herein as a possible interfering signal, other similar signals such as digital data or control signals or the like may be addressed by controlling their respective duty cycles as discussed herein, and the scope of the claimed subject matter is not limited in this respect.

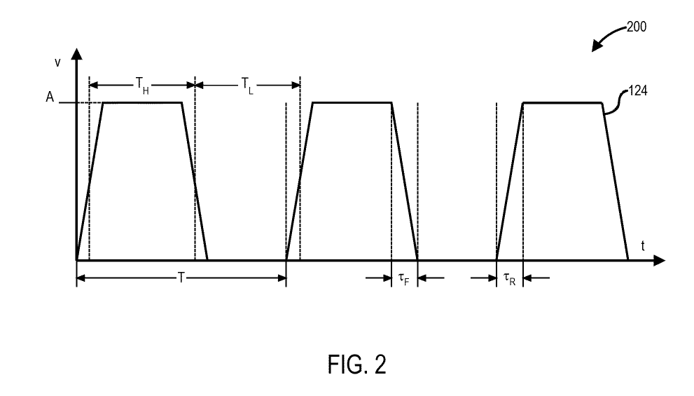

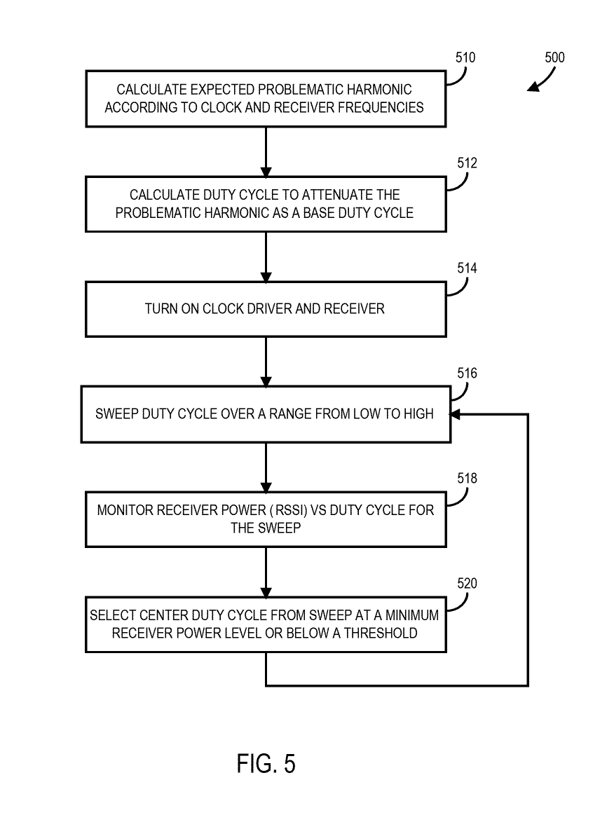

In one or more embodiments, to reduce or otherwise mitigate such RFI generated by the clock signal 124 transmitted from clock bus 126, a duty cycle controller 120 may monitor the input power at the RF receiver 118 via link 130, for example using a received signal strength indicator (RSSI) metric, an input noise measurement, an input signal amplitude, or an input signal fast Fourier transform (FFT), or similar measurement or metric, or some combination thereof. Power may be monitored at or near a harmonic of interest that may be predicted or calculated to cause RFI at the RF receiver 118. The duty cycle controller 120 may comprise a circuit, software executing on a processor or controller, or firmware, or combinations thereof, and the scope of the claimed subject matter is not limited in this respect. As discussed in further detail with respect to FIG. 5, below, the duty cycle controller 120 may adjust the duty cycle of the clock signal 124 by providing a duty cycle setting 132 to clock generator 112 to a select percentage of the nominal duty cycle of the clock signal 124, either slightly smaller or slightly greater than the nominal duty cycle, until the power level of the interfering harmonic is minimized or otherwise sufficiently reduced below a threshold value. In some embodiments, if there are two or more interfering harmonics, then the duty cycle may be adjusted by duty cycle controller 120 such that interference from the multiple harmonics is sufficiently minimized or below a threshold value for the harmonics collectively, or a local minima is achieved for at least a subset of the interfering harmonics. An example of how the duty cycle of a clock signal or similar signal may be controlled to reduce a harmonic power level is shown in and described with respect to FIG. 2, below.

Referring now to FIG. 2, a plot of an example clock signal in accordance with one or more embodiments will be discussed. As shown in FIG. 2, plot 200 using voltage v versus time t illustrates an example clock signal 124 that may be transmitted via clock bus 126. Assuming that the clock signal 124 is a square/trapezoidal wave with a rise time and fall time and a 50% duty cycle, the clock signal 124 may be mathematically described by a Fourier series for a square wave wherein the following equation results:

$${C}_{n} = A \frac{α T}{T} sin c ( n \frac{2 π}{T} \frac{α T}{2} ) sin c ( n \frac{2 π}{T} \frac{{τ}_{R}}{2} ) exp ( j n \frac{2 π}{T} \frac{α T + {τ}_{R}}{2} )$$

### Where:

Cₙ is the coefficient of the nth harmonic
τ_{R} is the rise and fall times (assuming rise time τ_{R}=fall time τ_{F})
α is the duty cycle factor (α=0.5 for 50% duty cycle)
T is the clock cycle time
A is the amplitude of the clock signal

It should be noted that clock signal 124 has a high or on value for a period of time T_{H} and a low or off value for a period of time T_{L}. The duty cycle D is a percentage calculated as the time on or high T_{H} divided by the clock cycle time T so that D=T_{H}/T×100. If it is assumed that τ_{R}<<T then the above equation may be rearranged as follows:

Cₙ=Aα sin c(nπα)exp(jnπα)

As a result, the amplitude of the harmonic Cₙ may be controlled by selecting an appropriate value of the duty cycle factor α of the clock signal. In one or more embodiments, the duty cycle factor α may be calculated such that it will zero the sin c((nπα) term, or

$$α = \frac{k}{n}$$

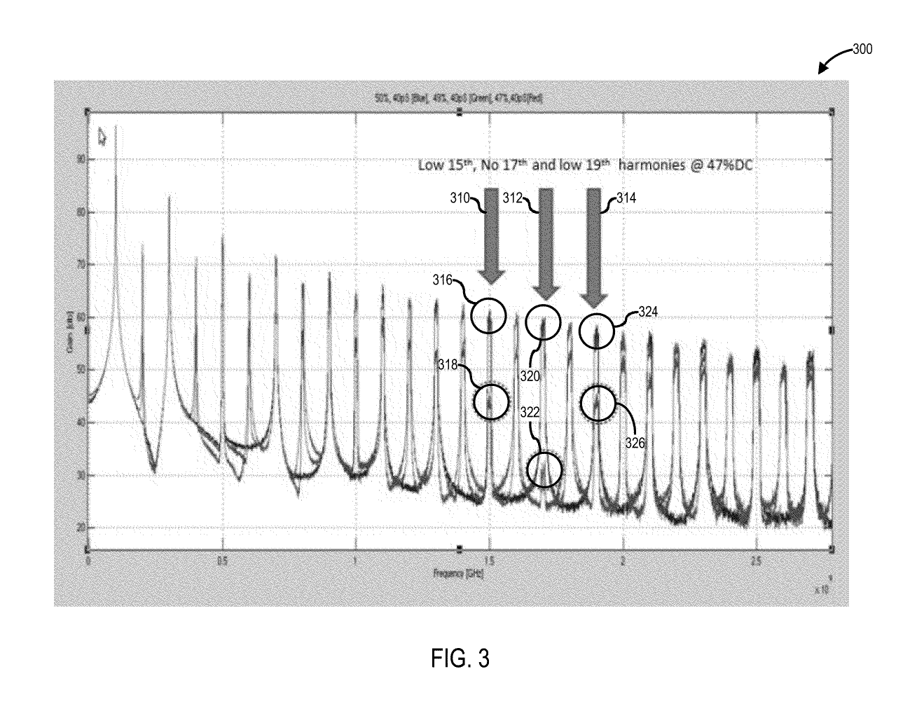

for any k where k=integer(n/2), that will result with duty cycle closest to 50%. Parameter n is the harmonic in question to be canceled or attenuated to address RFI. For example, to attenuate the 17^{th} harmonic use k=integer(17/2)=8, resulting in Duty Cycle α= 8/17=47.059%. It should be noted that the example shown for calculating the value of k may is merely one of several approaches to result in a duty cycle near 50%, however any value of k in the range of 1 to 16 may be sufficient wherein the sin c term is at or near zero, and the scope of the claimed subject matter is not limited in this respect. An example of how an amplitude of a clock signal harmonic may vary with duty cycle is shown in and described with respect to FIG. 3, below.

Referring now to FIG. 3, a plot of example harmonics of a clock signal at various duty cycles in accordance with one or more embodiments will be discussed. FIG. 3 shows the Spectrum plot 300 of a 100 MHz clock signal. As can be seen, the 15^{th} harmonic is shown at 310, the 17^{th} harmonic is shown at 312, and the 19^{th} harmonic is shown at 314. When the duty cycle is changed from 50% to 47%, the 15^{th} harmonic is attenuated from peak 316 to peak 318, the 17^{th} harmonic is attenuated from peak 320 to peak 322, and the 19^{th} harmonic is attenuated from peak 324 to peak 326. It can be seen, for example, that the 17^{th} harmonic is attenuated by approximately 30 dB when the duty cycle is adjusted from 50% to 47%. As a result, the duty cycle controller 120 may be capable of providing a duty cycle setting 132 to clock generator 112 in order to reduce the magnitude of a harmonic of the clock signal from clock bus 126 that may be responsible for RFI at the RF receiver 118 via coupled clock interference 128 by selecting an appropriate duty cycle. It should be noted that the clock power (energy) at clock bus 126 is much higher than the energy of clock signal 124 output from clock generator 112 due to driver 114. Thus, the clock signal on clock bus 126 may have more impact on crosstalk and RFI than at the output of clock generator 112. It should be further noted that the harmonics selected in this example (15^{th}, 17^{th} and 19^{th}) are not unique wherein other harmonics likewise may be attenuated by clock duty cycle control, and the scope of the claimed subject matter is not limited in this respect.

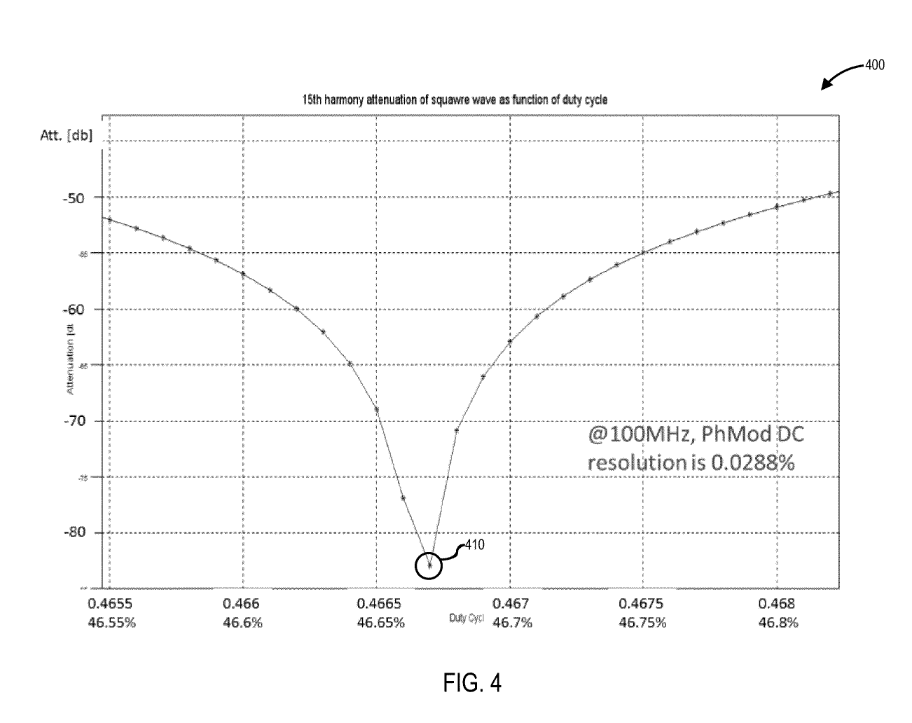

Referring now to FIG. 4, a plot of power versus duty cycle for an example harmonic of a clock signal in accordance with one or more embodiments will be discussed. In FIG. 4, the relationship between a specific clock signal harmonic and the clock duty cycle is shown in plot 400, in this case the 15^{th} harmonic of a 100 MHz clock signal 124. The power level of the 15^{th} harmonic is represented on the vertical axis as attenuation in dB versus duty cycle on the horizontal axis. Plot 400 shows that a relatively high level of attenuation is possible if a relatively high level of duty cycle resolution can be achieved. For example, greater than −60 dB of attenuation can be achieved at a clock duty cycle between about 46.65% and 46.7%. Furthermore, if the resolution of the clock duty cycle can be more finely controlled between 46.65% and 46.7%, then even greater attenuation of the 15^{th} harmonic may be achieved, for example up to greater than −80 dB of attenuation may be achieved at the minimum point 410 (maximum attenuation) as shown in order to achieve RFI mitigation. In one or more embodiments, an example clock generator 112 capable of generating a clock signal 124 having a controlled duty cycle may be tangibly embodied by dividing a high speed clock by an integer via an integer divider and a phase modulator circuit or a phase interpolator. For example, a 100 MHz clock can be achieved by dividing a 4 GHz clock by the integer 40 with an integer divider and using a phase modulator to provide phase modulation with a resolution of 1/32 of the 4 GHz clock summing to a resolution of 1/(40×32)= 1/1280 to provide <0.1% resolution. It should be noted, however, that this is merely one example of how a clock signal having a controlled duty cycle may be accomplished, and the scope of the claimed subject matter is not limited in this respect. A method for providing such RFI mitigation via duty cycle control for system 100 is shown in and described with respect to FIG. 5, below.

Referring now to FIG. 5, a flow chart of a method to mitigate RFI via duty cycle control in accordance with one or more embodiments will be discussed. Although FIG. 5 illustrates one particular order of a method 500 to mitigate radio-frequency interference (RFI) via duty cycle control, it should be noted that other orders are possible, and furthermore method 500 may include more or fewer blocks than shown in various other orders, and the scope of the claimed subject matter is not limited in these respects. At block 510, expected problematic harmonic frequencies may be calculated according to clock and receiver frequencies. For example, if RF receiver 118 operates in accordance with an Institute of Electrical and Electronics Engineers (IEEE) standard such as IEEE 802.11b standard at 2.4 GHz, then the harmonics of a given clock signal 124 that will appear in the vicinity of 2.4 GHz can be determined. For a Peripheral Component Interconnect (PCI) bus, the clock signal 124 may comprise a single-ended 3.3 V 33.333 MHz clock. Such a PCI clock may have a 74^{th} harmonic that falls at 2466.66 MHz that interferes with the IEEE 802.11b channel 11 of RF receiver 118. At block 512 the corresponding duty cycle of the clock signal 124 may be calculated that will attenuate one or more of these harmonics, and that calculated duty cycle may be set as the base or nominal duty cycle.

It should be noted that in one or more embodiments, the operations at block 510 and block 512 may be sufficient to mitigate RFI interference without requiring additional adjustments of the clock duty cycle. In one or more further embodiments, additional action may be taken to optimize RFI mitigation via power measurements at the input of RF receiver 118 in order to minimize RFI or otherwise have RFI mitigated below a threshold value. In such further embodiments, the clock driver 114 and RF receiver 118 may be turned on at block 514, and the initial duty cycle may be set to be slightly lower than the base duty cycle calculated at block 512. For example, the initial duty cycle may be set to 95% of the base duty cycle calculated at block 512. At block 516, the duty cycle may be swept from a lower value below the base duty cycle to high value above than the base duty cycle, for example from 95% to 105% of the base duty cycle. The power at the input of RF receiver 118 may be monitored at block 518 over the sweep range of the duty cycle to obtain power versus duty cycle. For example, a Received Signal Strength Indication (RSSI) metric may be obtained at the input of RF receiver 118. At block 520, the duty cycle from the sweep may be selected where the RSSI value is at a minimum or at least where the RSSI is below a threshold value. Duty cycle controller 120 may provide a duty cycle setting 132 to clock generator 112 to provide a clock signal at clock bus 126 at the selected center duty cycle. It should be noted that an actual duty cycle may comprise an effective duty cycle of different elements along the path on which clock signal 124 is propagated as more than one element may be RF coupled to RF receiver 118. Duty cycle controller 120 may account for such effective duty cycle due to multiple coupling paths, although the scope of the claimed subject matter is not limited in this respect.

In one or more embodiments, the operation of method 500 through block 522 may be enough to sufficiently mitigate RFI for system 100. In one or more additional embodiments, further adjustments to the duty cycle optionally may be made over time to ensure that RFI is optimally mitigated. For example, the temperature of system 100 or one or more silicon chips thereof may be monitored using a temperature sensor to obtain a temperature measurement, and further adjustments may be made where the duty cycle may change as a function of temperature. Additionally, the system 100 may continue to execute method 500 at least in part in order to monitor RSSI to minimize RFI or to maintain RFI below a threshold value, for example when the RF receiver 118 is idle so as to not disturb normal data reception. In such embodiments, method 500 may optionally execute any one or more of the operations at block 518, block 520, block 522, and/or block 524 one or more additional iterations and/or in a closed loop manner in order to continually or occasionally monitor RSSI, for example when the RF receiver 118 is idle, and to adjust the duty cycle of the clock signal as need to sufficiently mitigate RFI. In one or more such embodiments, the closed loop implementation of method 500 may operate to adapt RFI by adjusting clock duty cycle in real-time or near real-time. In some embodiments, RF receiver 118 may be switched to another frequency of operation in which case a different harmonic of the clock signal at clock bus 126 may be a new interferer. In such a case, method 500 may be executed to identify such a harmonic or harmonics, and the duty cycle of the clock signal may be adjusted accordingly to minimize or reduce such harmonics. Typically, duty cycle controller 120 is capable of adjusting the clock duty cycle to mitigate interference at one RF receiver 118. In some particular embodiments, duty cycle controller 120 is capable of adjusting the clock duty cycle to mitigate interference or other disturbances to two or more receivers, such as one Wi-Fi receiver, one Long Term Evolution (LTE) receiver, and one Bluetooth® receiver, by measuring harmonic interference for each respective receiver and adjusting the clock duty cycle of one or more interfering clock or digital signals accordingly, and the scope of the claimed subject matter is not limited in this respect. In some cases, the frequency of operation of two or more RF receivers or transceivers may be sufficiently close wherein a single duty cycle setting may mitigate RFI for both of the receivers or transceivers. Similarly, a different RF receiver may be switched on and operate in at a frequency of a different harmonic of the clock signal, in which case the duty cycle of the clock may be adjusted according to method 500 to reduce or mitigate RFI from such different harmonics. It should be noted that such embodiments of method 500 are merely example embodiments, and other embodiments of method 500 are possible and within the scope of the claimed subject matter, and the scope of the claimed subject matter is not limited in these respects.

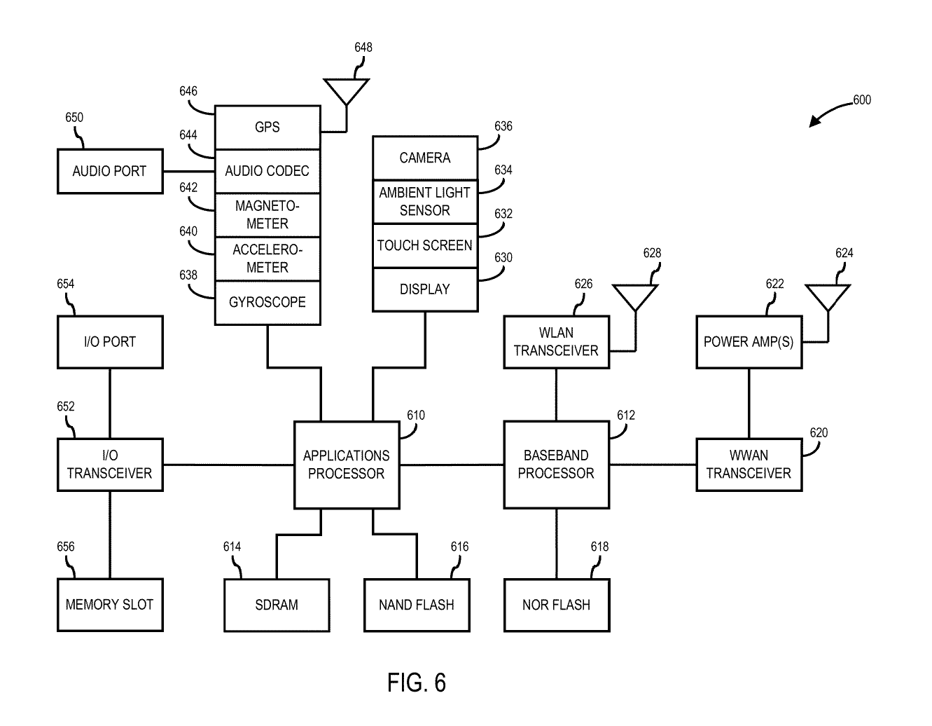

Referring now to FIG. 6, a block diagram of an information handling system capable of mitigating RFI via duty cycle control in accordance with one or more embodiments will be discussed. Information handling system 600 of FIG. 6 may tangibly embody system 100 as shown in and described with respect to FIG. 1, with greater or fewer components depending on the hardware specifications of the particular device. Although information handling system 600 represents one example of several types of computing platforms, information handling system 600 may include more or fewer elements and/or different arrangements of elements than shown in FIG. 6, and the scope of the claimed subject matter is not limited in these respects. In general, an information handling system 600 may include one or more clock signals, buses, or similar RF radiating element that each may affect one or more respective RF receivers or RFI sensitive circuits. In such embodiments, each RF radiating circuit may be adapted to control the duty cycle of a clock signal or similar signal to mitigate RFI for one more respective impacted receivers, for example via one or more duty cycle controllers 120, and the scope of the claimed subject matter is not limited in these respects.

In one or more embodiments, information handling system 600 may include an applications processor 610 and a baseband processor 612. Applications processor 610 may be utilized as a general purpose processor to run applications and the various subsystems for information handling system 600. Applications processor 610 may include a single core or alternatively may include multiple processing cores wherein one or more of the cores may comprise a digital signal processor or digital signal processing core. Furthermore, applications processor 610 may include a graphics processor or coprocessor disposed on the same chip, or alternatively a graphics processor coupled to applications processor 610 may comprise a separate, discrete graphics chip. Applications processor 610 may include on board memory such as cache memory, and further may be coupled to external memory devices such as synchronous dynamic random access memory (SDRAM) 614 for storing and/or executing applications during operation, and NAND flash 616 for storing applications and/or data even when information handling system 600 is powered off. In one or more embodiments, instructions to operate or configure the information handling system 600 and/or any of its components or subsystems to operate in a manner as described herein may be stored on a non-transitory article of manufacture comprising a storage medium. In one or more embodiments, the storage medium may comprise any of the memory devices shown in and described herein, although the scope of the claimed subject matter is not limited in this respect. Baseband processor 612 may control the broadband radio functions for information handling system 600. Baseband processor 612 may store code for controlling such broadband radio functions in a NOR flash 618. Baseband processor 612 controls a wireless wide area network (WWAN) transceiver 620 which is used for modulating and/or demodulating broadband network signals, for example for communicating via a 3GPP LTE or LTE-Advanced network or the like as discussed herein.

In general, WWAN transceiver 620 may operate according to any one or more of the following radio communication technologies and/or standards: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS),

Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), UMTS Terrestrial Radio Access (UTRA), Evolved UMTS Terrestrial Radio Access (E-UTRA), Long Tenn Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, and/or general telemetry transceivers, and in general any type of RF circuit or RFI sensitive circuit. It should be noted that such standards may evolve over time, and/or new standards may be promulgated, and the scope of the claimed subject matter is not limited in this respect.

The WWAN transceiver 620 couples to one or more power amps 622 respectively coupled to one or more antennas 624 for sending and receiving radio-frequency signals via the WWAN broadband network. The baseband processor 612 also may control a wireless local area network (WLAN) transceiver 626 coupled to one or more suitable antennas 628 and which may be capable of communicating via a Wi-Fi, Bluetooth®, and/or an amplitude modulation (AM) or frequency modulation (FM) radio standard including an IEEE 802.11 a/b/g/n standard or the like. It should be noted that these are merely example implementations for applications processor 610 and baseband processor 612, and the scope of the claimed subject matter is not limited in these respects. For example, any one or more of SDRAM 614, NAND flash 616 and/or NOR flash 618 may comprise other types of memory technology such as magnetic memory, chalcogenide memory, phase change memory, or ovonic memory, and the scope of the claimed subject matter is not limited in this respect.

In one or more embodiments, applications processor 610 may drive a display 630 for displaying various information or data, and may further receive touch input from a user via a touch screen 632 for example via a finger or a stylus. An ambient light sensor 634 may be utilized to detect an amount of ambient light in which information handling system 600 is operating, for example to control a brightness or contrast value for display 630 as a function of the intensity of ambient light detected by ambient light sensor 634. One or more cameras 636 may be utilized to capture images that are processed by applications processor 610 and/or at least temporarily stored in NAND flash 616. Furthermore, applications processor may couple to a gyroscope 638, accelerometer 640, magnetometer 642, audio coder/decoder (CODEC) 644, and/or global positioning system (GPS) controller 646 coupled to an appropriate GPS antenna 648, for detection of various environmental properties including location, movement, and/or orientation of information handling system 600. Alternatively, controller 646 may comprise a Global Navigation Satellite System (GNSS) controller. Audio CODEC 644 may be coupled to one or more audio ports 650 to provide microphone input and speaker outputs either via internal devices and/or via external devices coupled to information handling system via the audio ports 650, for example via a headphone and microphone jack. In addition, applications processor 610 may couple to one or more input/output (I/O) transceivers 652 to couple to one or more I/O ports 654 such as a universal serial bus (USB) port, a high-definition multimedia interface (HDMI) port, a serial port, and so on. Furthermore, one or more of the I/O transceivers 652 may couple to one or more memory slots 656 for optional removable memory such as secure digital (SD) card or a subscriber identity module (SIM) card, although the scope of the claimed subject matter is not limited in these respects.

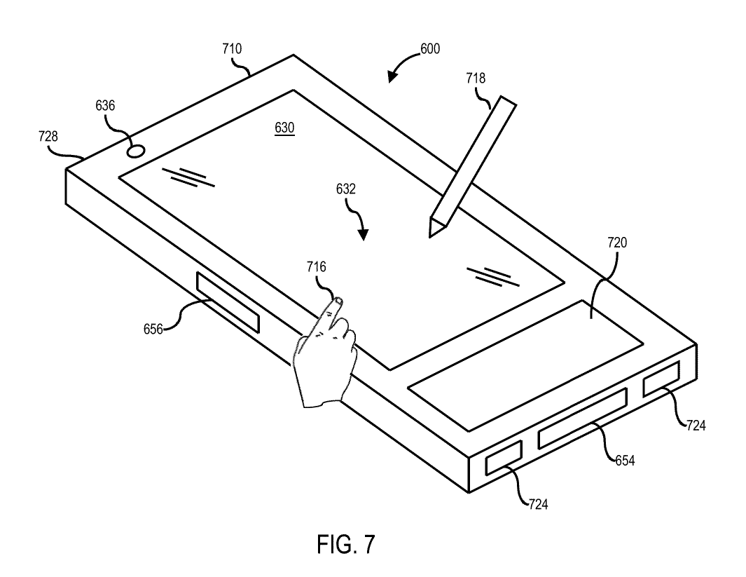

Referring now to FIG. 7, an isometric view of an information handling system of FIG. 6 that optionally may include a touch screen in accordance with one or more embodiments will be discussed. FIG. 7 shows an example implementation of information handling system 600 of FIG. 6 tangibly embodied as a cellular telephone, smartphone, or tablet type device or the like. In one or more embodiments, the information handling system 600 may comprise system 100 of FIG. 1, although the scope of the claimed subject matter is not limited in this respect. The information handling system 600 may comprise a housing 710 having a display 630 which may include a touch screen 632 for receiving tactile input control and commands via a finger 716 of a user and/or a via stylus 718 to control one or more applications processors 610. The housing 710 may house one or more components of information handling system 600, for example one or more applications processors 610, one or more of SDRAM 614, NAND flash 616, NOR flash 618, baseband processor 612, and/or WWAN transceiver 620. The information handling system 600 further may optionally include a physical actuator area 720 which may comprise a keyboard or buttons for controlling information handling system via one or more buttons or switches. The information handling system 600 may also include a memory port or slot 656 for receiving non-volatile memory such as flash memory, for example in the form of a secure digital (SD) card or a subscriber identity module (SIM) card. Optionally, the information handling system 600 may further include one or more speakers and/or microphones 724 and a connection port 654 for connecting the information handling system 600 to another electronic device, dock, display, battery charger, and so on. In addition, information handling system 600 may include a headphone or speaker jack 728 and one or more cameras 636 on one or more sides of the housing 710. It should be noted that the information handling system 600 of FIG. 7 may include more or fewer elements than shown, in various arrangements, and the scope of the claimed subject matter is not limited in this respect.

The following examples illustrate further embodiments that optionally may be implemented in whole or in part. Example 1 is an apparatus to reduce radio-frequency interference from a digital signal, the apparatus comprising a circuit having an input that is sensitive to radio-frequency interference at a selected frequency, a digital signal generator to generate a digital signal, and a duty cycle controller to control a duty cycle of the digital signal, wherein the duty cycle of the digital signal is capable of being adjusted to reduce a harmonic of the digital signal near the selected frequency of the circuit. Example 2 includes the subject matter of example 1, wherein the duty cycle is selected based at least in part on a power level of the harmonic measured at an input of the circuit such that the power level of the harmonic is minimized or reduced below a threshold level at the selected duty cycle. Example 3 includes the subject matter of example 2, optionally wherein the power level of the harmonic is based at least in part on a received signal strength indication (RSSI), an input noise measurement, an input signal amplitude, or an input signal fast Fourier transform (FFT), or combinations thereof. Example 4 includes the subject matter of example 1, optionally wherein the duty cycle controller is configured to sweep the duty cycle of the digital signal over a selected range and to set the duty cycle to a value at which a level of the harmonic is minimized or reduced below a threshold level. Example 5 includes the subject matter of example 1, optionally wherein the duty cycle controller is configured to monitor a power level of the harmonic during operation of the circuit, and to adjust the duty cycle of the digital signal in response to the monitored power level to maintain the power level at a minimum value or below a threshold value. Example 6 includes the subject matter of example 1, optionally wherein the circuit comprises an analog-to-digital converter (ADC), a sensor, an imaging circuit, a control circuit, a high speed circuit, a circuit having a high input impedance, a video circuit, a radio-frequency receiver, a radio-frequency transceiver, or combinations thereof. Example 7 includes the subject matter of example 1, optionally wherein the digital signal comprises a clock signal.

Example 8 is a method to control a duty cycle of a clock signal to mitigate radio-frequency interference, the method comprising determining a harmonic of a clock signal that is expected to provide interference with an input of a radio-frequency (RF) receiver based at least in part on a frequency of the clock signal and one or more frequencies of operation of the RF receiver, calculating a duty cycle of the clock signal at which the harmonic will be attenuated, and setting the duty cycle of the clock signal at the calculated duty cycle as a base duty cycle. Example 9 includes the subject matter of example 8, optionally further comprising sweeping the duty cycle over a sweep range from a first value that is lower than the base duty cycle to a second value that is higher than the base duty cycle, measuring a power level of the harmonic during said sweeping, and setting the duty cycle to a value in the sweep range at which the harmonic is minimized or reduced below a threshold value. Example 10 includes the subject matter of example 9, optionally wherein the power level is based at least in part on a received signal strength indicator (RSSI), an input noise measurement, an input signal amplitude, or an input signal fast Fourier transform (FFT), or combinations thereof obtained at the input of the RF receiver. Example 11, includes the subject matter of example 8, optionally further comprising monitoring the power level of the harmonic, and adjusting the duty cycle of the clock signal in response to the monitored power level to maintain the harmonic at the minimum value or at a value below the threshold value.

Example 12 is an information handling system, comprising a processor, a clock bus to propagate a clock signal, and a radio-frequency (RF) receiver to receive a wireless signal at an RF frequency of operation, wherein the processor is configured to control a duty cycle of the clock signal such that a harmonic of the clock signal is attenuated near frequency of operation of the RF receiver. Example 13 includes the subject matter of example 12, optionally wherein the clock bus comprises a local bus, a serial bus, a parallel bus, a processor bus, or a memory bus. Example 14 includes the subject matter of example 12, optionally wherein the processor is further configured to sweep the duty cycle over a sweep range from a first value that is lower than a base duty cycle to a second value that is higher than the base duty cycle, measure a power level of the harmonic during said sweeping, and set the duty cycle to a value in the sweep range at which the harmonic is minimized or reduced below a threshold value. Example 15 includes the subject matter of example 14, optionally wherein the power level measurement is based at least in part on a received signal strength indicator (RSSI), an input noise measurement, an input signal amplitude, or an input signal fast Fourier transform (FFT), or combinations thereof obtained at an input of the RF receiver. Example 16 includes the subject matter of example 12, optionally further comprising a display having a touch screen to receive an input to control the processor. Example 17 includes the subject matter of example 12, optionally wherein the information handling system comprises a user equipment (UE) and the RF receiver is capable of operating on a Long Term Evolution (LTE) network.

Example 18 is an article of manufacture comprising a non-transitory storage medium having instructions stored thereon that, if executed, result in sweeping a duty cycle of a clock signal over a sweep range from a first value that is lower than the base duty cycle to a second value that is higher than the base duty cycle, measuring a power level of the harmonic at an input of a radio-frequency transceiver during said sweeping, and setting the duty cycle to a value in the sweep range at which the harmonic is sufficiently attenuated to mitigate radio-frequency interference (RFI) with the RF receiver. Example 19 includes the subject matter of example 18, optionally wherein the power level measurement is based at least in part on a received signal strength indicator (RSSI), an input noise measurement, an input signal amplitude, or an input signal fast Fourier transform (FFT), or combinations thereof obtained at the input of the RF receiver. Example 20 includes the subject matter of example 18, optionally wherein the instructions, if executed, further result in monitoring the power level of the harmonic, and adjusting the duty cycle of the clock signal in response to the monitored power level to maintain the harmonic at the minimum value or at a value below the threshold value.

Example 21 is an apparatus to reduce radio-frequency interference from a digital signal, the apparatus comprising circuit means having an input that is sensitive to radio-frequency interference at a selected frequency, digital signal generator means to generate a digital signal, and duty cycle controller means to control a duty cycle of the digital signal, wherein the duty cycle of the digital signal is capable of being adjusted to reduce a harmonic of the digital signal near the selected frequency of the circuit means. Example 22 includes the subject matter of example 21, optionally wherein the duty cycle is selected based at least in part on a power level of the harmonic measured at an input of the circuit means such that the power level of the harmonic is minimized or reduced below a threshold level at the selected duty cycle. Example 23 includes the subject matter of example 22, optionally wherein the power level of the harmonic is based at least in part on a received signal strength indication (RSSI), an input noise measurement, an input signal amplitude, or an input signal fast Fourier transform (FFT), or combinations thereof. Example 24 includes the subject matter of example 21, optionally wherein the duty cycle controller means is configured to sweep the duty cycle of the digital signal over a selected range and to set the duty cycle to a value at which a level of the harmonic is minimized or reduced below a threshold level. Example 25 includes the subject matter of example 21, optionally wherein the duty cycle controller means is configured to monitor a power level of the harmonic during operation of the circuit, and to adjust the duty cycle of the digital signal in response to the monitored power level to maintain the power level at a minimum value or below a threshold value. Example 26 includes the subject matter of example 21, optionally wherein the circuit comprises analog-to-digital converter (ADC) means, sensor means, imaging circuit means, control circuit means, high speed circuit means, circuit means having a high input impedance, video circuit means, radio-frequency receiver means, radio-frequency transceiver means, or combinations thereof.

Example 27 is an apparatus comprising means to perform a method as claimed in any preceding example. Example 28 is machine-readable storage including machine-readable instructions stored thereon that, if executed, implement a method or realize an apparatus as claimed in any preceding example.

Although the claimed subject matter has been described with a certain degree of particularity, it should be recognized that elements thereof may be altered by persons skilled in the art without departing from the spirit and/or scope of claimed subject matter. It is believed that the subject matter pertaining to RFI mitigation via duty cycle control and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An apparatus to reduce radio-frequency interference from a digital signal, the apparatus comprising:
a circuit having an input that is sensitive to radio-frequency interference at a selected frequency;
a digital signal generator to generate a digital signal; and
a duty cycle controller to control a duty cycle of the digital signal, wherein the duty cycle of the digital signal is capable of being adjusted to reduce a harmonic of the digital signal near the selected frequency of the circuit.

2. An apparatus as claimed in claim 1, wherein the duty cycle is selected based at least in part on a power level of the harmonic measured at an input of the circuit such that the power level of the harmonic is minimized or reduced below a threshold level at the selected duty cycle.

3. An apparatus as claimed in claim 2, wherein the power level of the harmonic is based at least in part on a received signal strength indication (RSSI), an input noise measurement, an input signal amplitude, or an input signal fast Fourier transform (FFT), or combinations thereof.

4. An apparatus as claimed in claim 1, wherein the duty cycle controller is configured to sweep the duty cycle of the digital signal over a selected range and to set the duty cycle to a value at which a level of the harmonic is minimized or reduced below a threshold level.

5. An apparatus as claimed in claim 1, wherein the duty cycle controller is configured to monitor a power level of the harmonic during operation of the circuit, and to adjust the duty cycle of the digital signal in response to the monitored power level to maintain the power level at a minimum value or below a threshold value.

6. An apparatus as claimed in claim 1, wherein the circuit comprises an analog-to-digital converter (ADC), a sensor, an imaging circuit, a control circuit, a high speed circuit, a circuit having a high input impedance, a video circuit, a radio-frequency receiver, a radio-frequency transceiver, or combinations thereof.

7. An apparatus as claimed in claim 1, wherein the digital signal comprises a clock signal.

8. A method to control a duty cycle of a clock signal to mitigate radio-frequency interference, the method comprising:
determining a harmonic of a clock signal that is expected to provide interference with an input of a radio-frequency (RF) receiver based at least in part on a frequency of the clock signal and one or more frequencies of operation of the RF receiver;
calculating a duty cycle of the clock signal at which the harmonic will be attenuated; and
setting the duty cycle of the clock signal at the calculated duty cycle as a base duty cycle.

9. A method as claimed in claim 8, further comprising:
sweeping the duty cycle over a sweep range from a first value that is lower than the base duty cycle to a second value that is higher than the base duty cycle;
measuring a power level of the harmonic during said sweeping; and
setting the duty cycle to a value in the sweep range at which the harmonic is minimized or reduced below a threshold value.

10. A method as claimed in claim 9, wherein the power level is based at least in part on a received signal strength indicator (RSSI), an input noise measurement, an input signal amplitude, or an input signal fast Fourier transform (FFT), or combinations thereof obtained at the input of the RF receiver.

11. A method as claimed in claim 8, further comprising:
monitoring the power level of the harmonic; and
adjusting the duty cycle of the clock signal in response to the monitored power level to maintain the harmonic at the minimum value or at a value below the threshold value.

12. An information handling system, comprising:
a processor;
a clock bus to propagate a clock signal; and
a radio-frequency (RF) receiver to receive a wireless signal at an RF frequency of operation;
wherein the processor is configured to control a duty cycle of the clock signal such that a harmonic of the clock signal is attenuated near frequency of operation of the RF receiver.

13. An information handling system as claimed in claim 12, wherein the clock bus comprises a local bus, a serial bus, a parallel bus, a processor bus, or a memory bus.

14. An information handling system as claimed in claim 12, wherein the processor is further configured to:
sweep the duty cycle over a sweep range from a first value that is lower than a base duty cycle to a second value that is higher than the base duty cycle;
measure a power level of the harmonic during said sweeping; and
set the duty cycle to a value in the sweep range at which the harmonic is minimized or reduced below a threshold value.

15. An information handling system as claimed in claim 14, wherein the power level measurement is based at least in part on a received signal strength indicator (RSSI), an input noise measurement, an input signal amplitude, or an input signal fast Fourier transform (FFT), or combinations thereof obtained at an input of the RF receiver.

16. An information handling system as claimed in claim 12, further comprising a display having a touch screen to receive an input to control the processor.

17. An information handling system as claimed in claim 12, wherein the information handling system comprises a user equipment (UE) and the RF receiver is capable of operating on a Long Term Evolution (LTE) network.

18. An article of manufacture comprising a non-transitory storage medium having instructions stored thereon that, if executed, result in:
sweeping a duty cycle of a clock signal over a sweep range from a first value that is lower than the base duty cycle to a second value that is higher than the base duty cycle;
measuring a power level of the harmonic at an input of a radio-frequency transceiver during said sweeping; and
setting the duty cycle to a value in the sweep range at which the harmonic is sufficiently attenuated to mitigate radio-frequency interference (RFI) with the RF receiver.

19. An article of manufacture as claimed in claim 18, wherein the power level measurement is based at least in part on a received signal strength indicator (RSSI), an input noise measurement, an input signal amplitude, or an input signal fast Fourier transform (FFT), or combinations thereof obtained at the input of the RF receiver.

20. An article of manufacture as claimed in claim 18, wherein the instructions, if executed, further result in:
monitoring the power level of the harmonic; and
adjusting the duty cycle of the clock signal in response to the monitored power level to maintain the harmonic at the minimum value or at a value below the threshold value.
